(19) United States
(12) Patent Application Publication
(10) Pub. No.: US 2015/0175275 A2
(43) Pub. Date: Jun. 25, 2015

(54) SYSTEM AND METHOD FOR IMPROVING EFFICIENCY OF AIRCRAFT GATE SERVICES AND TURNAROUND

(71) Applicant: Borealis Technical Limited, North Plains, OR (US)

(72) Inventors: Isaiah W. Cox, London (GB); Joseph J. Cox, Portland, OR (US); Jan Vana, Prague (CZ)

(21) Appl. No.: 14/326,281

(22) Filed: Jul. 8, 2014

Related U.S. Application Data
(60) Provisional application No. 61/843,877, filed on Jul. 8, 2013.

(51) Int. Cl. B64F 1/305; B64F 1/30

(52) U.S. Cl. CPC B64F 1/305; B64F 1/30

(57) ABSTRACT

A system and method is provided for improving efficiency of aircraft gate services and reducing time spent by an aircraft parked parallel to an airport terminal wherein aircraft utilities and gate services provided during turnaround are supported by an arrangement of flexibly movable, service and utility-carrying extendable passenger boarding bridges that enable passenger and baggage exchange concurrently with connection of utilities and provision of gate services to the aircraft. Aircraft are maneuvered by a pilot into and out of a parallel parking location in a forward direction by an engines-off electric taxi system that does not rely on the use of aircraft main engines to drive the aircraft, enabling loading bridge, utility, and service connections to be made to multiple aircraft doors as soon as the aircraft arrives at a parking space and then quickly disconnected upon departure.

### PRIORITY CLAIM

This application claims priority from U.S. Provisional Patent Application No. 61/843,877, filed 8 Jul. 2013, the disclosure of which is fully incorporated herein.

### TECHNICAL FIELD

The present invention relates generally to turnaround activities and services provided at airport gates to aircraft between arrival and departure and specifically to a method for improving the efficiency of gate services and to improve turnaround and significantly reduce time aircraft spend on the ground at a gate between arrival and departure.

### BACKGROUND OF THE INVENTION

When aircraft land at most large airports today, they operate one or more of their main engines to power their ground travel as they taxi from a touchdown runway to an assigned terminal arrival gate. Although specific procedures may vary at different airports, most airport terminal gates are equipped with passenger loading bridges that are moved into place when an aircraft has arrived at the gate to provide a connection between the aircraft and the terminal. Currently, a loading bridge cannot be connected to an aircraft until the main engines powering the aircraft have been shut down, and it is safe to approach the aircraft. When the loading bridge has been connected to an aircraft door, usually the door closest to the forward or nose end of the aircraft, and the aircraft door has been opened, passengers and crew can leave the aircraft and walk to the terminal through the loading bridge. Loading bridges are designed to provide a pathway between an aircraft interior and an airport terminal building that shelters passengers and crew from the surrounding environment. While deplaning passengers are walking through a loading bridge to the terminal, ground service personnel and vehicles arrive at the aircraft to provide services required before the aircraft can depart from the gate for its next flight. At many airports, passengers may be required to walk down stairs that are either integral with the aircraft or brought to the aircraft by ground personnel. When the aircraft's engines are used for taxi, ground service personnel and vehicles cannot safely approach the aircraft until after the engines have been shut down, which adds time to aircraft turnaround.

Typically, before an aircraft is ready to depart a terminal gate, arriving passengers' baggage must be unloaded and departing passengers' baggage must be loaded, the aircraft must be fueled, lavatories may be cleaned and waste water removed, potable water may be supplied to the aircraft, trash may be removed and catering supplies may be delivered, among other services. The level of services provided depends, in part, on the airline operating the aircraft. A low cost carrier flying commuters between cities may not provide all of these kinds of services every time the aircraft turns around. An airline that flies long distance international flights is more likely to provide all of them.

The airline industry has recognized the importance of efficiently unloading and loading passengers and providing the requisite servicing of aircraft so aircraft can be turned around as quickly as possible to maintain an airline's flight schedule and achieve the highest aircraft utilization possible. Moreover, an airline's potential profits may be increased the less time an aircraft is on the ground and the more time it is in flight. It has been estimated by one source that every saved minute of a turnaround has the potential to save about $1 million per aircraft per year, depending on the number of flights and flight days an airline operates.

To increase the efficiency with which passengers can be moved out of and into aircraft, especially very large aircraft that have multiple entrances and two passenger levels, some airport terminal gates have two loading bridges available for such aircraft that can be extended either horizontally or vertically to service aircraft using two different doors. In one arrangement, an “over-the-wing” bridge is designed to be connected to an aircraft's rear door while a conventional loading bridge is connected to the aft door to provide two passenger loading bridges for Airbus 319-321 and Boeing 737 aircraft. Such an arrangement is described in U.S. Pat. No. 7,039,978 to Hutton and is also available from FMT Aircraft Gate Support Systems of Sweden. This type of passenger loading bridge must be designed to clear the aircraft wing height, also allowing for the height of winglets on the tips of most aircraft wings, and maneuvering the bridge into place can pose some challenges.

Another type of dual passenger loading bridge system is described and shown in U.S. Pat. Nos. 7,275,715 and 7,614,585, assigned to Boeing. This complex system, which is designed to be used with an aircraft parked perpendicular to a terminal building in a “nose-in” orientation, may also include structure for handling baggage and cargo and for providing some aircraft utilities. The Boeing system has an arrangement of lateral bridge extensions that are required to connect one or more main bridge sections to doors on one or both sides of the aircraft. Although the intent of a dual passenger loading system, such as the Boeing system and the over-the-wing type of system, is to allow faster passenger egress and ingress, that objective has not always been achieved. It has been observed that the when dual loading bridges are available, the practice has been to use one loading bridge for first and business class passengers and the other for economy class passengers.

For a number of years, aircraft utilities have been attached to passenger loading bridges and connected to aircraft to supply, for example, electric power, temperature and humidity-conditioned air, and compressed air to an aircraft at a gate during the turnaround process. In U.S. Pat. No. 3,521,316, Adams et al describes providing these utilities to an aircraft concurrently with passenger boarding. The service transport unit described by McEntire et al in U.S. Pat. No. 5,149,017 includes a utility bundle attached to and designed to extend and retract with a passenger loading bridge, and the loading bridge-mounted heat exchanger with extensible supply and return lines described by Shepheard in U.S. Pat. No. 4,620,339 provides utilities to a parked aircraft. The foregoing arrangements avoid the need for providing such aircraft services by separate conduits or connections not associated with a landing bridge and reduce the numbers of such structures in a terminal gate area.

U.S. Pat. No. 5,505,237 to Magne discloses a partially or completely automated aircraft refueling installation integrated into a passenger loading bridge to eliminate or reduce the need for fuel vehicles in a gate area. Improving aircraft gate turnaround by increasing the efficiency of gate services is not a stated goal of the systems in this or in the aforementioned patents.

The loading bridge arrangements described above, whether or not aircraft utilities are connected with the loading bridge, are all premised on providing connections with aircraft that are parked in a “nose-in” orientation relative to an airport terminal building so that the longest axial dimension of the aircraft is perpendicular to the terminal building. Consequently, passenger loading bridges are constructed to that they can be extended between the terminal and the aircraft at an angle that will provide an effective connection. Many passenger loading bridges have rotundas or the like that can rotate and thus facilitate the connection between a loading bridge and an aircraft door, but alignment may still pose challenges. When aircraft are able to park so that the longest axial dimension is not perpendicular, but parallel, to a terminal building, extension and alignment of passenger loading bridges with aircraft doors is much simplified.

The advantages of moving an aircraft into a parking location parallel to a terminal and connecting a parallel parked aircraft to a terminal building were acknowledged by Hutton in U.S. Pat. No. 7,039,978. Hutton further emphasized very significant disadvantages presented by parallel parking an aircraft. It was noted that, not only do the aircraft maneuvers for parallel parking required greater terminal façade length than the nose-in orientation, but that departure of an aircraft from a parked parallel position requires substantial engine thrust to start and turn the aircraft. Additionally, engine exhaust from a turning aircraft is directed toward a terminal building, ground equipment, and personnel, disrupting ground operation activities. In U.S. Pat. No. 3,184,772, Moore et al describe and show an aircraft parked parallel to a terminal building with dual passenger loading bridges designed to provide connections to forward and aft aircraft doors, which facilitates alignment of the loading bridges with the aircraft. This arrangement, however, does not address the other stated disadvantages associated with parking an aircraft parallel to a terminal building.

A need exists, therefore, for a system and method for improving efficiency of aircraft gate services and turnaround. A need further exists for improved multiple function passenger loading bridges designed to be connected efficiently to multiple doors in an aircraft parked in an orientation parallel to an airport terminal building that provide efficient passenger egress and ingress simultaneously with aircraft gate servicing, thereby improving the efficiency of servicing and minimizing time an aircraft spends at a gate.

### SUMMARY OF THE INVENTION

It is a primary object of the present invention, therefore, to provide a system and method for increasing the efficiency of servicing of an aircraft parked in an orientation parallel to a terminal building at a terminal gate that provides efficient passenger egress and ingress simultaneously with providing aircraft gate servicing, thereby improving the efficiency of servicing and minimizing time an aircraft spends at a gate.

It is another object of the present invention to provide a system and method for improving efficiency of airport gate operations at an airport where aircraft are moved into a gate area and parked parallel to a terminal building without operation of aircraft main engines.

It is an additional object of the present invention to provide a system and method for improving efficiency of servicing of aircraft parked parallel to an airport terminal to reduce time spent at a terminal gate.

It is a further object of the present invention to provide a system and method for reducing time spent by an aircraft parked parallel to an airport terminal, wherein aircraft utilities and utility services are supported by an arrangement of a plurality of passenger boarding bridges and associated structures that enable passenger and baggage egress and ingress concurrently with connection of utilities and provision of utility services to the aircraft.

It is yet another object of the present invention to provide a system and method for improving efficiency of airport gate services and turnaround that minimizes the number of service vehicles required to service an aircraft during turnaround.

It is yet an additional object of the present invention to provide a system and method for improving the safety of gate servicing and operations that eliminates the need to extend one loading bridge over an aircraft wing when two loading bridges are connected to an aircraft during gate operations.

It is yet a further object of the present invention to provide a method for efficiently providing passenger and utility services to minimize aircraft time at an airport gate wherein aircraft are maneuvered into and out of a parking location parallel to the gate independently without operation of the aircraft's engines or use of a tow vehicle by an engines-off electric taxi system.

It is a still further object of the present invention to provide a system and method for improving efficiency of aircraft gate services and turnaround that employs a combination of loading bridges supporting aircraft utilities and/or services designed for quick connection to doors and service ports on a terminal side of an aircraft parked parallel to a terminal and stairs on an opposite side of the aircraft that may be either integral to the aircraft or portable to maximize passenger egress and ingress through a maximum number of doors while the aircraft is being serviced.

In accordance with the aforesaid objects, a system and method is provided for improving efficiency of aircraft gate services and reducing time spent by an aircraft parked parallel to an airport terminal, wherein aircraft utilities and utility services are supported by an arrangement of a plurality of passenger boarding bridges and associated structures that enable passenger and baggage egress and ingress concurrently with connection of utilities and provision of utility services to the aircraft. Additionally in accordance with the present system and method, aircraft are maneuvered into and out of a parallel parking location in a forward direction powered by an engines-off electric taxi system that does not rely on the use of the aircraft main engines to drive the aircraft. Passenger loading bridges and utility connections can be made as soon as the aircraft arrives at a designated parking space. It is preferred to support as many aircraft utilities as possible on the plurality of loading bridges to enable connection of these utilities when the loading bridges are connected to the aircraft. All connections are designed to connect quickly and efficiently and then to disconnect quickly and efficiently when servicing is complete so that the loading bridges can be retracted from the aircraft, and the aircraft is ready to be driven away from the parallel parking location within a minimum amount of time after arrival. To further maximize efficiency, aircraft stairs can be used for passenger transfer through aircraft doors not connected to loading bridges.

Other objects and advantages will be apparent from the following description, drawings, and claims.

### BRIEF DESCRIPTION OF THE DRAWINGS

FIG. 1 is a diagrammatic representation of an airport terminal with aircraft parked parallel to a terminal building and shows aircraft maneuvering with an engines-off electric taxi system into and out of a gate with multiple boarding bridges for connection to the parallel parked aircraft

FIG. 2 is a diagrammatic illustration of an aircraft equipped with an engines-off electric taxi system parked parallel to an airport terminal building with connected dual passenger loading bridges and aircraft utilities and servicing connections supported by and associated with the boarding bridges; and

FIG. 3 is a flow chart describing a method for improving efficiency of aircraft gate services according to the present invention.

### DESCRIPTION OF THE INVENTION

The advantages of parking an aircraft parallel to an airport terminal building and the ability to facilitate terminal connections between forward and aft aircraft doors and passenger loading bridges have been recognized. Until the present invention, however, it has not been possible to overcome the major disadvantages associated with moving aircraft into parallel parking locations at an aircraft terminal building so that passengers and baggage may efficiently leave and enter an aircraft parked in a parallel orientation while an aircraft is simultaneously connected to selected utilities required for servicing the aircraft. Aircraft have not previously been able to move autonomously during ground travel without thrust from the aircraft main engines, and operation of aircraft engines in the vicinity of terminal gates poses safety challenges. The present invention provides a system and method for improving the efficiency with which an aircraft can be serviced and turned around at an airport terminal gate that enables an aircraft to travel, without operation of main engines, in a forward direction into a parking location parallel to a gate or terminal building, exchange arriving and departing passengers and baggage, be serviced concurrently while exchanging passengers, move in a forward direction out of the parking place, and taxi to a takeoff runway.

The present system and method not only increases the efficiency of gate operations, but it also increases the safety of gate operations by eliminating jet blast and engine ingestion hazards associated with operating aircraft engines near an airport terminal and the ground personnel and vehicles needed to support engines-on taxi. Aircraft taxi, parking, and ground travel in the present system are controlled primarily by aircraft pilots, who control aircraft ground maneuvers into and out of gate parallel parking locations. The efficiency of passenger movement into and out of a parked aircraft is maximized by the ability to use all, or at least a maximum number of, aircraft passenger doors for deplaning and boarding concurrently with the servicing of an aircraft. Flexibly movable passenger loading bridges can be extended to connect with a parallel parked aircraft and then retracted to maximize space at a parking location so an aircraft has a least a minimum clearance required to turn and leave the parking location at departure. This arrangement also permits more aircraft to fit into parking spaces parallel to a terminal. Since utilities and servicing connections may be supported on the loading bridges, servicing of aircraft can begin upon the aircraft's arrival at a parking space as soon as the passenger loading bridge is extended and the required connections with the aircraft are made. Loading bridge-supported utilities and/or services are preferably designed to be quickly connected to and disconnected from corresponding aircraft utility and service ports or other connections. Additionally, the present system may be partially or completely automated to further improve the efficiency of airport gate operations.

To achieve maximum efficiency of airport gate operations and to minimize the time required for gate operations as described herein, aircraft are equipped with an engines-off electric taxi system. In a preferred engines-off electric taxi system, an electric drive means is mounted within one or more landing gear wheels to power and rotate one or more of these wheels and to move the aircraft autonomously on the ground without reliance on aircraft main engines or tow vehicles. The preferred location for electric drive means in the preferred electric taxi system is the aircraft nose landing gear wheels. Providing drive means on one or more main landing gear wheels may also be suitable in some aircraft.

A preferred drive means for an engines-off electric taxi system is an electric motor assembly, preferably powered by the aircraft auxiliary power unit, that is capable of operating at a torque and speed required to move an aircraft landing gear wheel and, therefore, an aircraft on the ground. An example of one of a number of suitable types of electric drive means useful in an aircraft landing gear drive wheel that could be used effectively in the present gate traffic management system is an inside-out electric motor in which the rotor can be internal to or external to the stator, such as that shown and described in U.S. Patent Application Publication No. 2006/0273686, the disclosure of which is incorporated herein by reference. A range of motor designs capable of high torque operation across a desired speed range that can move a commercial-sized aircraft wheel and function as described herein may also be suitable electric drive means in an engines-off electric taxi system used to move aircraft into and out of terminal gates as described herein. A high phase order electric motor of the kind described in, for example, U.S. Pat. Nos. 6,657,334; 6,838,791; 7,116,019; and 7,469,858, the disclosures of the aforementioned patents being incorporated herein by reference, may be effectively used as an electric drive means in an engines-off electric taxi system. One particularly suitable electric drive means is a high phase order induction motor with a top tangential speed of about 15,000 linear feet per minute and a maximum rotor speed of about 7200 rpm, although other electric drive means capable of a wide range of such speeds could be used in an engines-off electric taxi system to drive aircraft into and out of terminal gate parking spaces as described herein.

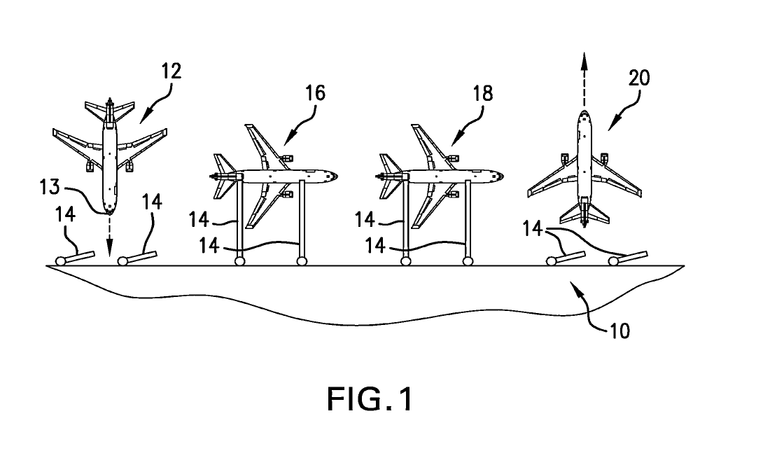

Referring to the drawings, FIG. 1 illustrates several aircraft taxiing toward, parked parallel to, and taxiing away from an airport terminal building 10. The aircraft are not shown drawn to scale. An arriving aircraft 12 is shown approaching the terminal 10 in a forward direction with the aircraft nose aimed toward the terminal and the longest axis of the aircraft perpendicular to the terminal. Flexibly movable extendable passenger loading bridges 14, as described below, are retracted as close to the terminal 10 as possible to provide maximum space for the aircraft 12 to maneuver into a parallel parking position. Aircraft 16 and 18 are shown parked parallel to the terminal 10 at a designated gate location, with the passenger loading bridges 14 fully extended to connect to each aircraft. To assume this orientation, each aircraft rotates or turns 90° to park with the longest axis of the aircraft parallel to the terminal 10. The flexibly movable loading bridges 14 may be spaced along the face of the terminal to accommodate connections to two aircraft doors. The loading bridges 14 remain in a retracted position close to the terminal and away from aircraft parking spaces to facilitate parking of the aircraft parallel to the terminal. Upon arrival at the terminal 10, an aircraft may turn as described and travel parallel to the terminal, if required, to an assigned parking space, which may be at a designated gate. An aircraft may also make this turn at the parking space. Two or more flexibly movable extendable loading bridges 14 may be provided for each aircraft parking space. Loading bridges 14 are shown extended to connect with the front and rear doors of aircraft 16 and 18. It is also possible to use access stairs (not shown) that are either integral with the aircraft or portable to maximize passenger egress and ingress from the aircraft by using doors that face away from the terminal 10. Stairs may be lowered or moved into place as soon as the aircraft has stopped in a parallel parking location without danger to ground personnel or passengers.

When an aircraft is ready for departure, the loading bridges 14 may be moved away from the aircraft and retracted to clear the parking space, and the aircraft pilot can activate and control the engines-off electric taxi system to turn the aircraft 90° so the nose is directed away from the terminal. If used, stairs are simultaneously moved away from aircraft doors. Departing aircraft 20 is shown driving away from the terminal 10.

All of the aircraft movements shown in FIG. 1 are in a forward direction. This enables an aircraft pilot to keep the aircraft travel area in view when the aircraft approaches the terminal and when the pilot is maneuvering the aircraft into or out of a terminal parking space. While not necessary with the present system, it is also possible to drive an aircraft in reverse by controlling the electric drive means of the electric taxi system to move the aircraft in reverse, should reverse movement be required.

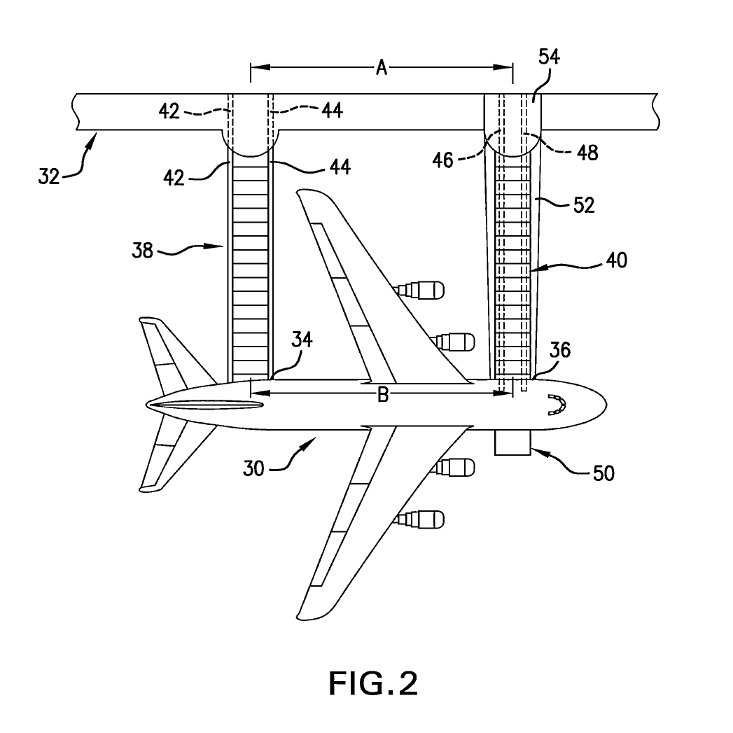

FIG. 2 shows an aircraft 30 parked parallel to a terminal building 32. The aircraft shown has respective aft and forward doors (not shown) at locations 34 and 36 on the port side of the aircraft. Dual loading bridges 38 and 40 extend from the terminal 32 to connect, respectively, with the doors at the aircraft aft and forward locations 34 and 36. Loading bridges currently used by airports are designed to connect to an aircraft parked in a “nose-in” orientation and typically must be extensively maneuvered to provide an accurate connection, usually with the aircraft's forward door. The loading bridges 38 and 40 may be spaced a distance apart A that corresponds to a distance B between the doors of aircraft of a type most frequently assigned to a gate parking location to facilitate alignment and connection of the loading bridges with the aircraft. Loading bridges may still require some maneuvering to accommodate and enable connection with aircraft of different types and with different door positions.

The preferred passenger loading bridges shown herein may be designed to allow them to extend toward and connect with an aircraft to permit passenger movement and aircraft servicing and then retract toward the terminal building 32 to maximize a clear area around an aircraft to permit the aircraft to move forward, turn 90°, and leave a gate or terminal as described above. There are available passenger loading bridge designs that may accomplish this basic purpose. A preferred flexibly movable extendable loading bridge design permits the loading bridge to be extended to connect with an aircraft and then retracted when disconnected to occupy minimal space. Loading bridges may also be collapsible in three dimensions and may move vertically upward or downward as required to make the connections desired and to avoid contact with aircraft wings. Loading bridges with a collapsible and extendible concertina-type structure, as well as loading bridges on wheels, are also available and may be used as described herein. A “pop-up” loading bridge that is raised from and lowered into a ground space may also be useful in the present system. One suitable type of loading bridge useful in the present invention is an extendable and retractable loading bridge available under the name of Crystal Bridge from ThyssenKrupp Airport Systems. Any other passenger loading bridge that may provide a connection between a parked aircraft to transfer passengers directly between a terminal and the aircraft and can then be collapsed, folded, retracted, or otherwise moved efficiently out of the parking space to provide a maximum area for aircraft turning and maneuvering as discussed above is contemplated for use in the present invention.

For some models of aircraft that have two passenger levels, a double level loading bridge may be provided. A double level loading bridge may be configured to provide passenger access to aircraft doors on both passenger levels. Aircraft utilities and services may be connected to one or both loading bridges, depending on locations of an aircraft's utility or service connections.

Not only should a loading bridge be easily moved into and out of connection with an aircraft, but a loading bridge should be capable of adaptation to support a range of aircraft utilities and services. Loading bridges currently support utilities such as electrical connections between a terminal and an aircraft while an aircraft is parked at a gate. The present system and method for improving gate service efficiency and turnaround adapts passenger loading bridges to support as many utilities and service connections as possible to facilitate and speed up gate servicing and turnaround. Utilities and services supported by a loading bridge in the present system are preferably designed to connect quickly and efficiently to corresponding aircraft utilities and service ports or other connections and to disconnect as quickly and efficiently. FIG. 2 illustrates some services and utilities that may be supported or carried by a loading bridge and connected to an aircraft when the loading bridges 38 and 40 are connected to the aircraft 30. These services are intended solely as examples, and it is contemplated that other utilities and/or services may also be supported by one or more loading bridges as described herein.

When an aircraft is serviced between arrival and departure, waste water is removed and a supply of fresh water is provided. Conduits that may be used for this purpose may be attached to a loading bridge, such as loading bridge 38, preferably on the surface facing the tarmac surface. For example, a conduit 42 may direct waste water from a waste water holding tank (not shown) on the aircraft to a waste water disposal (not shown) in a service area of the terminal 32 or elsewhere. A separate conduit 44 may direct fresh water from a fresh water supply (not shown) in the terminal to a fresh water tank (not shown) on the aircraft. Other conduits (not shown) may also be provided to move brown water or other waste from the aircraft 30 to a disposal facility in a terminal or ramp area. The conduits should be designed and formed of a material able to extend and retract with the loading bridge and remain functional after many such extensions and retractions. Connections should be designed to be secured as quickly as possible when the loading bridge is extended and unsecured as quickly as possible when it is retracted.

Electrical connections and the like may also be supported by a loading bridge. For example, electrical connections and/or conditioned air connections 46 and 48 may be attached to loading bridge 40 to provide a connection between a terminal electric system (not shown) and the aircraft electric system or between a heat exchanger in the terminal (not shown) and the aircraft air circulation system to provide electricity and cooled or heated air to the interior of the aircraft and the loading bridge while the aircraft 30 is parked. Although the aircraft main engines are not intended to be used to power movement of the aircraft into and out of a parallel parking location as described herein, a loading bridge may also carry a supply of compressed air to start an engine in the event the auxiliary power unit is inoperative or ground power is not sufficient. Electrical lines and air handling lines may also be adapted to extend and retract with the passenger loading bridge so that they are available to connect with the aircraft's corresponding lines when the loading bridge is connected to the aircraft. Connections and disconnections should be designed to be accomplished quickly and easily.

A baggage handling extension arm 50 may be provided, depending whether the cargo bay door faces the terminal, to connect with a baggage and cargo conveyor 52 that extends under a loading bridge, such as loading bridge 40, to transfer baggage to a baggage transfer location 54 within the terminal 32. Depending on the model and orientation of the aircraft, a conveyor 52 may be directly connected to the aircraft's cargo bay, and the baggage handling extension arm 50 would not be needed. A baggage conveyor and/or a baggage handling extension may be mounted to extend and retract with the loading bridge or to extend into and out of a holding and storage location near the terminal baggage transfer location 54.

The present invention further contemplates using loading bridges to provide other turnaround services, such as catering and refueling, for example. Catering supplies may be delivered through one of the loading bridges. A refueling system associated with a loading bridge is proposed in U.S. Pat. No. 5,505,237, the disclosure of which is incorporated herein by reference.

When an aircraft's doors or ports are not directly aligned with utility or other service connections on a side of an aircraft facing a terminal where loading bridges connect to the aircraft, attachments or extensions may be provided on the loading bridge to extend under or around the aircraft fuselage to enable the proper connections to be made.

For each service that may be connected or associated with a passenger loading bridge, a ground service vehicle is not needed to provide the service and, therefore, may be eliminated. Removal of vehicles from an airport gate and ramp environment reduces congestion in this area and minimizes the chance of errors, collisions and other incidents involving damage and/or injury to ground vehicles and personnel. As a result, costs for ground operations, including insurance costs, may be significantly reduced with the present system and method. Additionally, airport ground staff may be able to service aircraft with minimal or no exposure to adverse weather conditions.

Additional improvements in efficiency are possible when a maximum number of an aircraft's doors are used during passenger exchange and aircraft servicing. Turnaround efficiency may be further improved when a combination of terminal-to-aircraft connections with utilities and/or services-supporting passenger loading bridges as described above and stairs at doors not connected to loading bridges is employed. Since aircraft engines are not used to drive aircraft into terminal parallel parking locations in accordance with the present system and method, stairs may be lowered from an aircraft or moved into place by ground personnel as soon as the aircraft comes to a stop at its parking location.

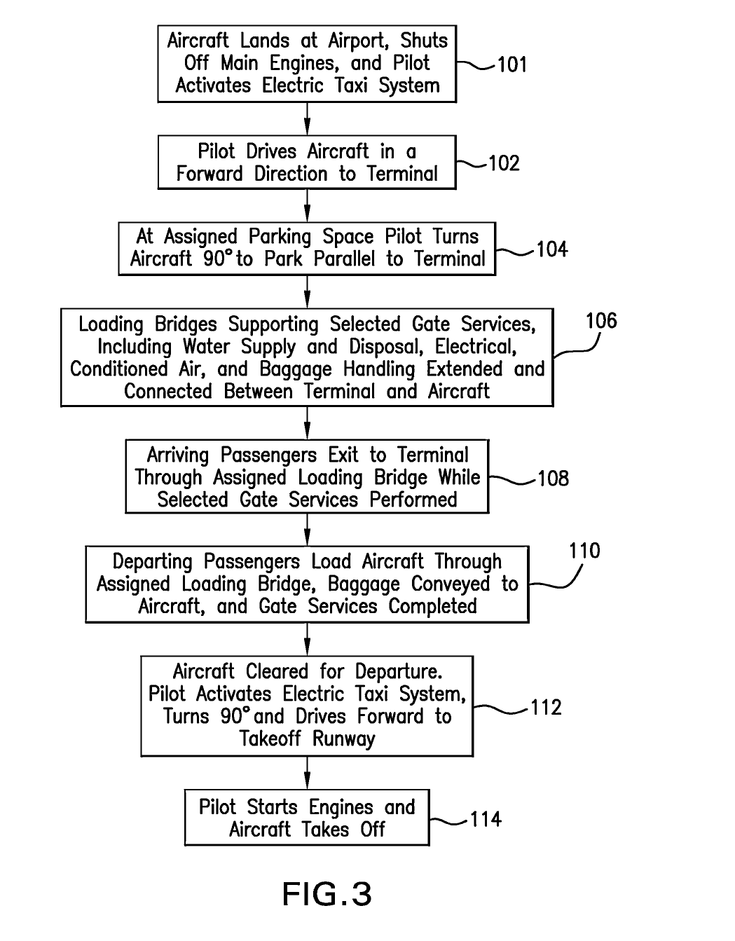

Most aircraft typically have at least forward and aft doors on opposite sides of the aircraft. Providing additional doors in an aircraft's body that may be connected to additional utility and service-supporting passenger loading bridges and/or to additional sets of stairs may further improve aircraft gate servicing and turnaround efficiency. For example, in addition to the two loading bridges 14 connected to each aircraft in FIG. 1, or the two utility and service connection-supporting loading bridges 38 and 40 connected to aircraft 30 in FIG. 3, three or more additional loading bridges may be connected to corresponding aircraft doors. One or more aircraft windows may be replaced with doors to accomplish this. If, for example, an aircraft window at the end of an exit row over the center of a wing is replaced with a door, a passenger loading bridge may be adapted to permit passenger egress and ingress in that location. The significant improvements in efficiency of passenger transfer and aircraft servicing and the reduction in aircraft gate time and costs possible with the present invention when a combination of loading bridges and stairs are used may justify the initial expense of such aircraft modifications.

FIG. 3 is a flow chart representing, in boxes 101-114, the present method for improving efficiency of aircraft gate servicing and turnaround when aircraft are equipped with engines-off electric taxi systems. After an aircraft lands, the pilot shuts off the main engines and activates the aircraft's engines-off electric taxi system. (101) The pilot drives the aircraft in a forward direction to a terminal ramp area. (102) At an assigned gate or parking location, the pilot turns the aircraft 90° to park the aircraft with the longest axial dimension of the aircraft parallel to the terminal and then deactivates the electric taxi system. (104) Loading bridges supporting selected gate services or utilities, including at least water supply and disposal, electrical, conditioned air, and baggage handling, are extended from the terminal toward the aircraft and connected to each aircraft door on the terminal side of the aircraft. Services and utilities connections between the terminal and aircraft may be secured when the lading bridge is in place. If used, stairs may be lowered or moved into place by ground personnel. (106) Passengers arriving at the terminal exit through an assigned loading bridge, and/or by assigned stairs, to the terminal while arriving baggage is conveyed to the terminal, and the aircraft is serviced. (108) Departing passengers load the aircraft through an assigned loading bridge, and/or by assigned stairs, while departing baggage is conveyed from the terminal to the aircraft, and gate servicing is completed. (110) The aircraft is cleared for departure, and the pilot activates the engines-off electric taxi system, turns the aircraft 90° to head away from the terminal, and drives the aircraft to a takeoff runway. (112) At a suitable location, the pilot starts the aircraft main engines, and the aircraft takes off, a minimum amount of time after arrival. (114)

While the present invention has been described with respect to preferred embodiments, this is not intended to be limiting, and other arrangements and structures that perform the required functions are contemplated to be within the scope of the present invention.

### INDUSTRIAL APPLICABILITY

The system and method for improving efficiency of aircraft gate services and turnaround of the present invention will find its primary applicability where it is desired to take advantage of the benefits of moving aircraft during ground travel with engines-off electric taxi and parking these aircraft parallel to an airport terminal provided with service and utility—carrying loading bridges to enable concurrent passenger and baggage exchange and aircraft servicing.

1. A method for improving aircraft gate servicing and turnaround efficiency comprising:
a. equipping an aircraft with an engines-off electric taxi system controllable to power aircraft taxi, and activating and controlling said electric taxi system to drive the aircraft in a forward direction from a landing location to a parking location at an airport terminal;
b. turning the aircraft and parking the aircraft in said parking location in an orientation wherein a longest axis of said aircraft is parallel to the terminal, whereby passenger access doors in at least forward and aft locations in said aircraft body are facing the terminal;
c. providing a number of flexibly movable extendable passenger loading bridges corresponding to a number of passenger access doors in said aircraft body and selected gate service supply and utility connections supported by said loading bridges to supply or perform selected gate utilities and services during turnaround, wherein said passenger loading bridges and gate service supply and utility connections are attached at a terminal end to said terminal;
d. extending each of the passenger loading bridges to connect at an end opposite the terminal end to the at least forward and aft access doors to provide multiple passages between the aircraft and the terminal, and connecting said gate service supply and utility connections at an end opposite the terminal end to corresponding service and utility connections on said aircraft;
e. directing arriving passengers to exit the aircraft and enter the terminal and departing passenger to leave the terminal and enter the aircraft concurrently while said selected gate services are performed and utilities are supplied to the aircraft; and
e. when all departing passengers have entered the aircraft and all selected gate services and utilities have been provided and said aircraft is cleared for departure, activating the engines-off electric taxi system to turn said aircraft and drive the aircraft in a forward direction away from said terminal to a takeoff runway.

2. The method of claim 1, wherein said aircraft has at least one forward passenger access door and one aft passenger access door, and passengers are directed to exit and enter one or the other access door.

3. The method of claim 2, further comprising providing two passenger loading bridges supporting aircraft services and utilities and connecting one passenger loading bridge to a forward aircraft door and a second passenger loading bridge to an aft aircraft door.

4. The method of claim 1, further comprising providing selected gate services comprising baggage handling services and one or more of supplying aircraft fresh water, removing aircraft waste water, providing electrical connections, providing conditioned air, providing catering supplies, and providing aircraft fuel.

5. The method of claim 1, further comprising extending and retracting said gate service supply and utility connections supported on said loading bridge when said loading bridge supporting said supply connections is extended and retracted, and providing connectors at the end of the service supply and utility opposite the terminal end whereby said gate service supply and utility connections may be quickly connected to and disconnected from the corresponding service and utility connections on said aircraft.

6. The method of claim 5, further comprising providing selected gate services and utilities comprising at least baggage handling services, providing a supply of aircraft fresh water, removing aircraft waste water, providing electrical connections, providing conditioned air, providing catering supplies, and providing aircraft fuel on a loading bridge located closest to aircraft connections for a selected gate serviced or utility.

7. The method of claim 4, wherein said baggage handling service is provided by accessing an aircraft cargo bay with a baggage handling extension of said loading bridge and conveying baggage to said terminal with a conveyor supported under one of said loading bridges.

8. The method of claim 1, further comprising beginning performance of said selected gate services as soon as said gate service supply and utility connections are connected to said aircraft and completing said selected gate services by at least the time departing passenger boarding is completed.

9. The method of claim 1, further comprising providing passenger access stairs at one or more doors in said aircraft body facing away from the terminal or not connected to a loading bridge and directing passengers to exit or enter the aircraft using the loading bridges and the stairs.

10. The method of claim 1, further comprising eliminating a corresponding ground service vehicle from an airport ramp area for each selected gate service supported by said passenger loading bridges and supplied directly to said aircraft when the passenger loading bridge and the service are connected to the aircraft.

11. A method for improving efficiency of aircraft turnaround and reducing ramp congestion, comprising
a. driving an aircraft in only a forward direction into and out of a terminal parking area to park parallel with a forward and rear access door facing the terminal;
b. providing passenger loading bridges with a plurality of selected aircraft gate services and utilities attached to or supported by the passenger loading bridges connected to the terminal;
c. extending the passenger loading bridges to connect with the aircraft forward and aft access doors so that the selected services and utilities attached to or supported by each passenger loading bridge are connected with corresponding service and utility connections on the aircraft to establish service and utility connections and passenger access between the terminal and aircraft; and
d. concurrently with arriving and departing passenger egress and ingress out of and into the aircraft, performing and supplying each selected gate service and utility, thereby minimizing numbers of service vehicles and time required to service the aircraft and transfer passengers.

12. The method of claim 11, wherein the plurality of selected gate services and utilities comprises at least baggage handling services, providing a supply of aircraft fresh water, removing aircraft waste water, providing electrical connections, providing conditioned air, providing catering supplies, and providing aircraft fuel on a loading bridge located closest to aircraft connections for a selected gate serviced or utility.

13. The method of claim 11, further comprising providing stairs for aircraft access doors not connected to passenger loading bridges and directing passengers to enter or leave the aircraft using all aircraft access doors, thereby minimizing time required to transfer passengers and maximizing efficiency of turnaround.

14. The method of claim 12, further comprising supporting selected ones of the plurality of selected gate services and utilities on a passenger loading bridge connected to the aircraft forward access door and selected others of the plurality of gate services and utilities on a passenger loading bridge connected to the aircraft aft access door.

15. The method of claim 14, further comprising supporting a selected gate service or utility on a passenger loading bridge closest to an aircraft connection for the selected gate service or utility, whereby the selected gate service or utility supported by a passenger loading bridge and the aircraft may be connected quickly when the passenger loading bridge is extended to connect with an aircraft access door and disconnected quickly when the passenger loading bridge is moved away from the aircraft access door.

16. A system for performing the method of claim 1, comprising an aircraft equipped with an electric taxi system designed to drive the aircraft in a forward direction to park in an orientation with a longest axis parallel to a terminal, at least two doors on a side of the aircraft facing the terminal, and connection for services; and at least two passenger loading bridges adapted to support a plurality of said selected gate service connections and to connect said terminal with said aircraft, wherein said loading bridges are designed to connect with aircraft doors to provide passenger egress and ingress and to connect said plurality of gate service connections directly with corresponding aircraft service connections.
